(19) United States
(12) Patent Application Publication
(10) Pub. No.: US 2009/0116694 A1
(43) Pub. Date: May 7, 2009

(54) DEVICE FOR MEASURING AN AERIAL IMAGE PRODUCED BY AN OPTICAL LITHOGRAPHY SYSTEM

(75) Inventor: Yasuyuki Unno, Irvine, CA (US)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/934,733

(22) Filed: Nov. 2, 2007

(51) Int. Cl. G06K 9/00; B05D 1/12

(52) U.S. Cl. 382/106; 427/180

(57) ABSTRACT

An image measuring device that measures an aerial image, with relatively small or no dependence on the incident angle and polarization state of the beams projected onto the measuring device. The aerial image measuring device includes a substrate in which there are photo-luminescent nanoparticles that isotropically emit a photo-luminescent wavelength in response to an illuminated wavelength of the aerial image, a filter that blocks the illuminated wavelength and is transparent to the photo-luminescent wavelength, and a light detector that is sensitive to light of the photo-luminescent wavelength. The substrate is transparent to light of both the illuminated and the photo-luminescent wavelength, and the aerial image passes through the substrate and illuminates the nanoparticles. The photoluminescent light emitted by the nanoparticles passes through the filter and enters the light detector, which measures the aerial image. The aerial image is scanned by the aerial image measuring device

### BACKGROUND OF THE INVENTION

1. Field of the Invention

The invention relates to aerial image measurement, and more particularly relates to measuring an aerial image produced by an optical lithography system.

2. Description of the Related Art

FIG. 1 shows the configuration of a typical optical lithography system 1 used for the manufacturing of semiconductor devices. A pattern 5 on reticle 2 is illuminated by illumination system 4, thereby creating an image 240 of pattern 5. Projection lens 7 projects image 240 of pattern 5 onto wafer 3 (positioned on wafer stage 6).

To evaluate the effects of lens aberrations, illumination conditions, and other factors that affect the imaging performance of the lithography system 1, aerial image 240 is measured by aerial imaging measuring device 200 (positioned on wafer stage 6). By moving wafer stage 6 along the X and/or Y direction, aerial image 240 can be measured by measuring device 200.

FIG. 2 shows the basic configuration of a typical aerial image measuring device 200 that may be positioned on wafer stage 6 of FIG. 1. Device 200 has an aperture 211 through which light beams of a predetermined wavelength can pass. Light beams that compose aerial image 240 pass through aperture 211 and reach detector 230, which can measure the intensity of aerial image 240 at a given position. To measure the image intensity distribution of aerial image 240 along, for example, the X-axis, device 200 scans aerial image 240 in the X direction. These aerial image measurements can be used to create an aerial image profile, which can be used to evaluate the image quality of optical lithography system 1.

### SUMMARY OF THE INVENTION

A limitation of aerial image measuring devices (e.g., 200 of FIG. 2) noticed by the inventor herein is that aerial image measurements may depend upon the incident angle and polarization state of beams projected onto the measuring device. Because an aerial image is created by the interference of these beams, changes in the properties of these beams may affect measurements of the aerial image.

In FIG. 3, the aerial image (e.g., 240 of FIG. 2) is created by the interference of beams 350 and 360. The polarization directions of beams 350 and 360 may be changed as they pass through aperture 211 to reach detector 230, which measures beams 350 and 360. As a result, the measured image intensity distribution of the aerial image may not represent the actual image intensity distribution of the aerial image.

Furthermore, the amplitude of beams 350 and 360 may decrease as they pass through aperture 211, based on incident angles θ₁ and θ₂, respectively. FIG. 4 shows the relationship between the beam incident angle (e.g., θ₁ and θ₂) and the amplitude transmittance of an aperture onto a measuring device (e.g., 200). As shown in FIG. 4, as incident angle θ increases, the amplitude of each beam (e.g., 350 and 360) decreases. Therefore, the amplitude of beams 350 and 360, as measured by detector 230, may not represent the actual amplitude of beams 350 and 360, respectively.

Because typical aerial image measuring devices (e.g., 200) may not accurately measure an aerial image for the foregoing reasons, aerial image profiles created from those measurements may not be accurate. Thus, these aerial images profiles may not accurately represent the imaging performance of an optical lithography system (e.g., 1).

The present invention addresses this effect, by providing an image measuring device that measures an aerial image, with relatively small or no dependence on the incident angle and polarization state of the beams projected onto the measuring device.

According to one aspect of the invention, a wavelength conversion element is provided in an aerial image measuring device, so as to reduce or substantially eliminate dependence on incident angle and polarization state. More particularly, the aerial image measuring device includes a substrate in which there are photo-luminescent nanoparticles that isotropically emit a photo-luminescent wavelength in response to an illuminated wavelength of the aerial image, a filter that blocks the illuminated wavelength and is transparent to the photo-luminescent wavelength, and a light detector that is sensitive to light of the photo-luminescent wavelength. The substrate is transparent to light of both the illuminated and the photo-luminescent wavelength, and the aerial image passes through the substrate and illuminates the nanoparticles. The photoluminescent light emitted by the nanoparticles passes through the filter and enters the light detector, which measures the aerial image. The aerial image is scanned by the aerial image measuring device.

The nanoparticle can have a size smaller than both the illuminated wavelength and a feature size of the aerial image. The nanoparticles can have a substantially spherical shape and can be arranged in columns.

Using this image measuring device to measure an aerial image is likely to result in more accurate aerial image profiles because the nanoparticles respond to an incident light beam isotropically, independent of the incident angle and the incident polarization state. Because of the nanoparticle's isotropic emission, and reinforced in nanoparticles having a spherical shape, the photo-luminescent light is emitted uniformly into the surrounding space. Thus, the portion of this photo-luminescent light detected by the light detector is not significantly affected by the incident angle or polarization state of the incident light from the aerial image. Furthermore, because of the nanoparticle's small size, the measuring device may provide a high resolution capable of measuring small structures in an aerial image. Thus, the image measuring device may result in more accurate aerial image profiles.

The nanoparticles can have a size between 5 nm and 20 nm in diameter and can include Si, ZnO, and Ge nanoparticles. The substrate can include a SiO2 substrate and the nanoparticles can be nanocrystals. The nanoparticles can be arranged in the substrate so that they do not touch each other.

The image measuring device can have at least one light-blocking layer that blocks the illuminated wavelength, and the light-blocking layer can be arranged to reduce an amount of light of the illuminated wavelength that reaches the filter. The image measuring device can have a lens arranged to guide light of the photo-luminescent wavelength to the light detector. At least one reflecting surface can be arranged to deflect light of the photo-luminescent wavelength to the light detector. By virtue of the light blocking layer, lens, and reflecting surfaces, a more accurate aerial image profile can be attained.

According to another aspect of the invention, an image measuring device used to measure an aerial image is fabricated. A mask layer is deposited on a substrate, an opening is formed on the mask layer, ions of a nanoparticle are implanted in the substrate through openings in the mask layer, the mask layer is removed from the substrate, and the ions are annealed in the substrate to form nanoparticles. The nanoparticles are photo-luminescent nanoparticles that emit a photo-luminescent wavelength in response to an illuminated wavelength, and the substrate is transparent to light of both the illuminated and the photo-luminescent wavelength.

The ions can be annealed in a manner adapted to produce nanoparticles having a size smaller than both the illuminated wavelength of the aerial image and a feature size of the aerial image. A light-blocking layer can be deposited onto the substrate and an opening in the light blocking layer can be created. A width of the opening in the light blocking layer can be larger than an illuminated wavelength of the aerial image. The light detector can be insensitive to the illuminated wavelength.

This brief summary has been provided so that the nature of the invention may be understood quickly. A more complete understanding of the invention can be obtained by reference to the following detailed description of the preferred embodiment thereof in connection with the attached drawings.

### BRIEF DESCRIPTION OF THE DRAWINGS

FIG. 1 show the configuration of a typical optical lithography system used for the manufacturing of semiconductor devices.

FIG. 2 shows the basic configuration of a typical aerial image measuring device that is equipped on a wafer stage.

FIG. 3 shows the polarization directions of beams being changed by a measuring device.

FIG. 4 shows the relationship between the beam incident angle and the amplitude transmittance of an aperture onto a measuring device.

FIG. 5A shows the configuration of an aerial image measuring device according to an embodiment of the invention.

FIG. 5B shows a top view of the measuring device of FIG. 5A.

FIG. 6 is a graph showing the properties of a filter used by an aerial image measuring device, according to an aspect of the invention.

FIG. 7 shows the photoluminescence intensity of photo-luminescent light emitted by nanoparticles used by an aerial image measuring device, according to an aspect of the invention.

FIG. 8 shows the measuring device of FIG. 5A with multiple columns of nanoparticles, according to an embodiment of the invention.

FIG. 9 shows the measuring device of FIG. 5A with light-blocking layers, according to an embodiment of the invention.

FIG. 10 shows the measuring device of FIG. 9 with a lens, according to an embodiment of the invention.

FIG. 11 shows the measuring device of FIG. 10 with a multilayer coating and reflecting surfaces, according to an embodiment of the invention.

FIG. 12 is a graph showing the properties of a multilayer coating, according to an embodiment of the invention.

FIG. 13 shows the configuration of an aerial image measuring device, according to an embodiment of the invention

FIGS. 14A to 14F and 14D′ to 14F′ depict a process for fabricating an image measuring device, according to an embodiment of the invention.

FIGS. 15A, 15B, 16A, and 16B, depict top views of image measuring devices, according to different embodiments of the invention

### DETAILED DESCRIPTION

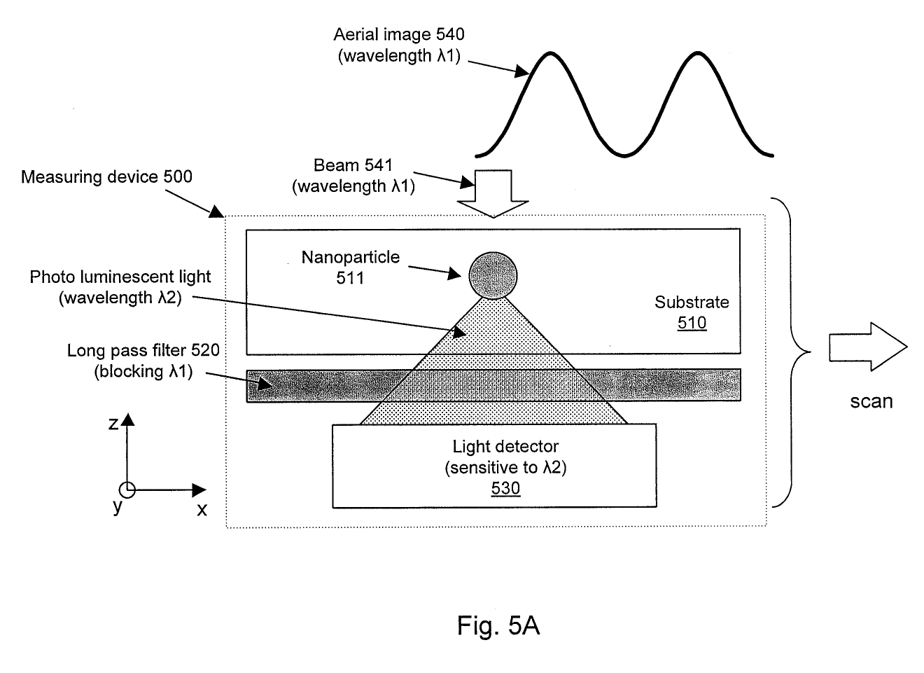

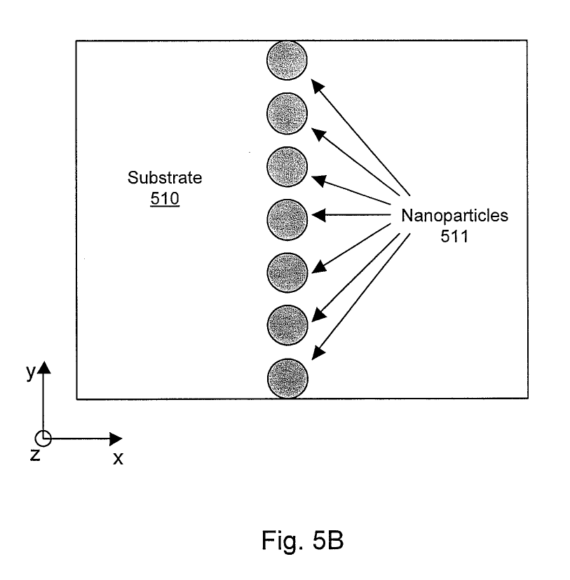

FIGS. 5A shows the configuration of an aerial image measuring device 500 according to embodiments of the invention. Aerial image measuring device 500 includes a substrate 510, a light detector 530, and a filter 520 positioned between substrate 510 and light detector 530, as illustrated in FIG. 5A.

Nanoparticles 511 are embedded in substrate 510, and arranged in a column along the Y-axis, as shown in FIG. 5B (which depicts a top view of measuring device 500 of FIG. 5A). Nanoparticles 511 are arranged within substrate 510 in a manner such that individual nanoparticles 511 do not touch each other.

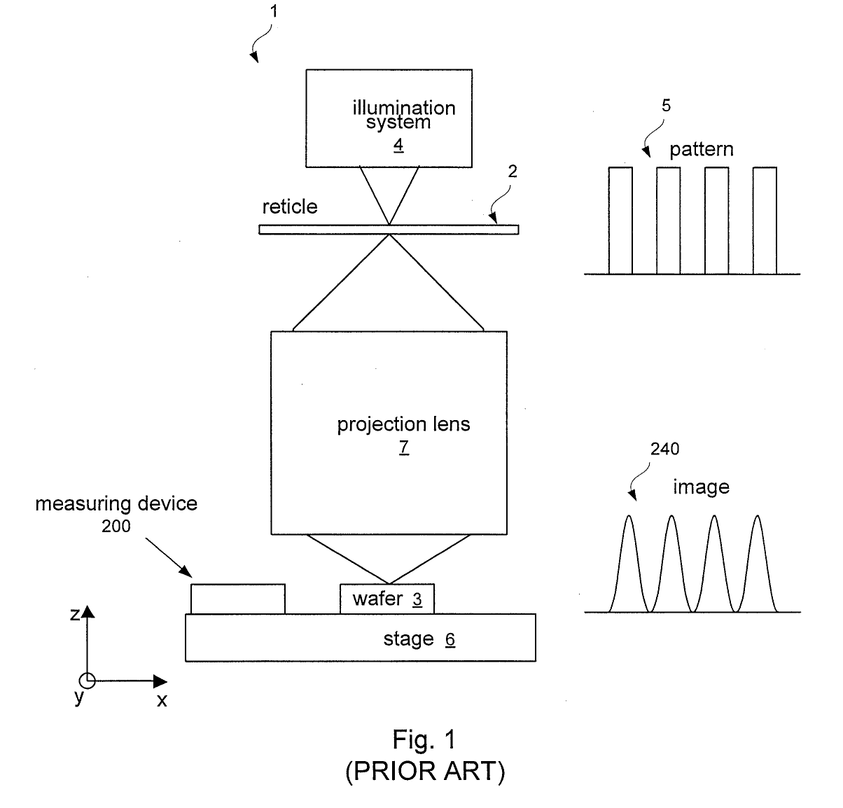

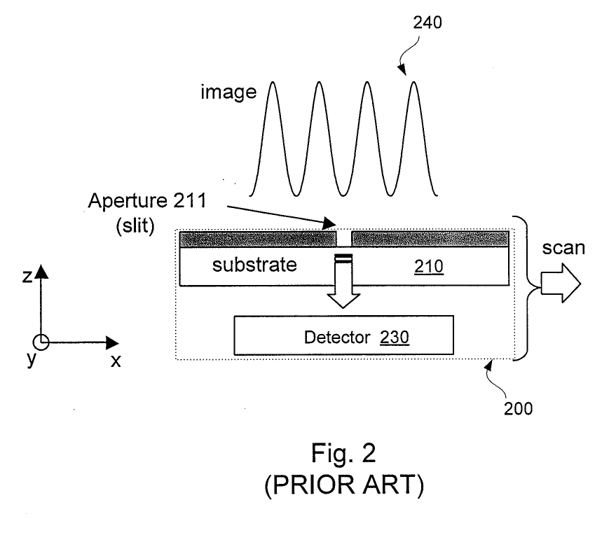

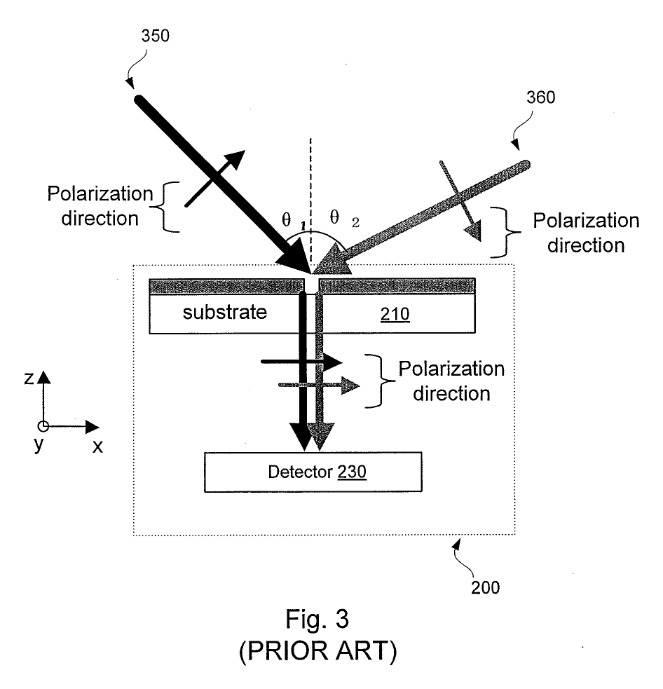

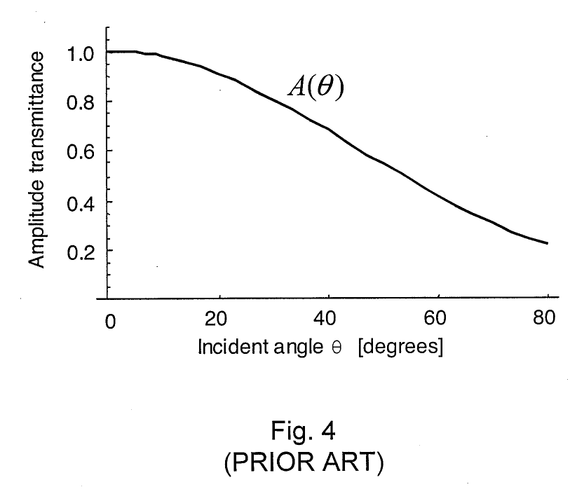

Nanoparticles 511 are between 5 nm and 20 nm in diameter, and are smaller than both the illuminated wavelength λ1 and a feature size of aerial image 540. In optical lithography systems, such as the system shown in FIG. 1, that use ArF excimer lasers for illumination, the illuminated wavelength λ1 is typically 193 nm.

Nanoparticles 511 can include, for example, substantially spherical Si, ZnO, or Ge nanocrystals, or any other nanoparticles that isotropically emit a photo-luminescent wavelength λ2 in response to an illuminated wavelength λ1 of aerial image 540. This photo-luminescent wavelength λ2 is different from illuminated wavelength λ1; in this embodiment, it is longer than the illuminated wavelength λ1. Substrate 510 is a SiO2 substrate, or any other substrate from within which nanoparticles 511 can isotropically emit a photo-luminescent wavelength λ2 in response to an illuminated wavelength λ1 of aerial image 540. Substrate 510 is transparent to light of both the illuminated wavelength λ1 and the photo-luminescent wavelength λ2.

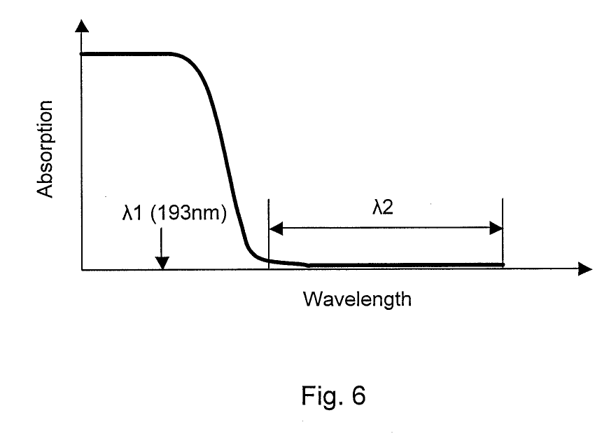

Filter 520 is a filter, such as for example, a long pass filter, having the properties illustrated in FIG. 6, wherein the filter 520 blocks the illuminated wavelength λ1 and is transparent to the photo-luminescent wavelength λ2 emitted by nanoparticles 511. As shown in FIG. 6, beams of wavelength λ1, are blocked by absorption and beams in the λ2 wavelength range are transmitted.

Light detector 530 is sensitive to light of the photo-luminescent wavelength λ2 emitted by nanoparticles 511, and in this embodiment, is not sensitive to wavelength λ1.

In operation, the measuring device 500 is positioned on a wafer stage of an optical lithography system (e.g., the wafer stage depicted in FIG. 1), and the wafer stage is controlled to scan aerial image 540 (formed by the optical lithography system) across the X-axis to measure the intensity distribution of the aerial image. Beams (e.g., 541) of aerial image 540 (having wavelength λ1) enter substrate 510, and illuminate nanoparticles 511. In response to this illumination, nanoparticles 511 isotropically emit photo-luminescent light (having wavelength λ2) uniformly into the surrounding space. This photo-luminescent light passes through filter 520 where λ1 is blocked, leaving λ2 to enter light detector 530, which measures the aerial image.

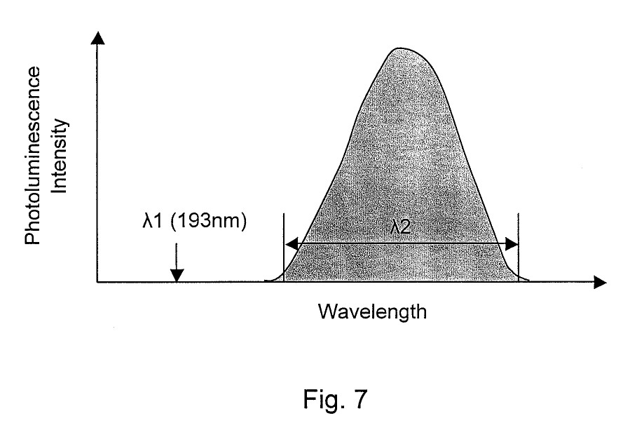

FIG. 7 shows the photoluminescence intensity of photo-luminescent light emitted by nanoparticles 511 that are Si nanocrystals. The range of λ2 depends on the crystal size, and can be adjusted to match the wavelength sensitivity of the photo detector. Because the amount of light intensity emitted by the Si nanocrystal is proportional to the light intensity illuminating the Si nanocrystal, the aerial image distribution of the wavelength λ1 can be determined based on the measurements for the wavelength λ2.

By using multiple nanoparticles 511, more light energy of the λ1 wavelength is transformed to the λ2 wavelength, thus resulting in a higher signal-to-noise ratio. Furthermore, because each nanoparticle may have slightly different optical properties due to the shape deviation from an ideal sphere, using multiple nanoparticles may reduce the effect of such deviations, thereby resulting in more accurate measurements.

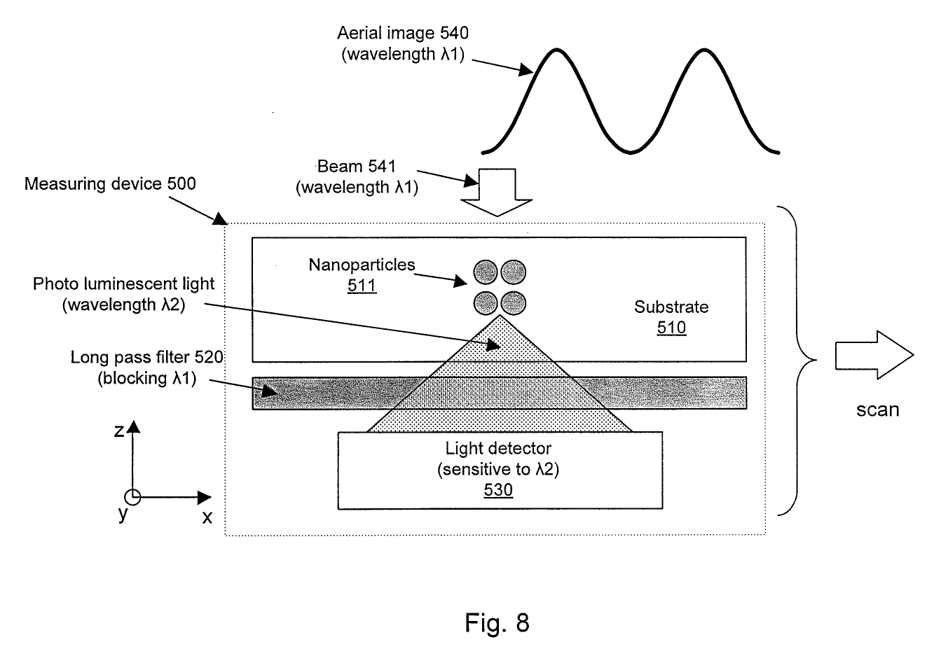

In addition to arranging nanoparticles 511 in a column along the Y-axis (as shown in FIG. 5B), multiple nanoparticles 511 can be arranged in the XZ-plane, as shown in FIG. 8, to further reduce the effect of shape deviation from an ideal sphere, and increase the signal-to-noise ratio.

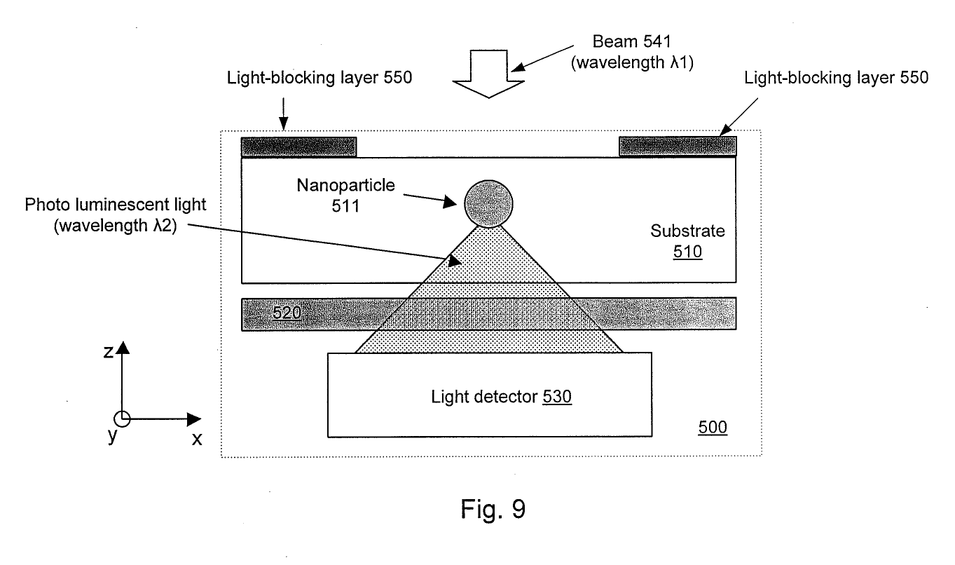

Light-blocking layers 550 can be added to measuring device 500, as shown in FIG. 9, to increase the signal-to-noise ratio. Light-blocking layers 550 block the illuminated wavelength λ1, and are arranged on the upper surface of substrate 510 to reduce the amount of light of wavelength λ1 that reaches filter 520. The opening between the light-blocking layers 550 is larger than the wavelength λ1. Light-blocking layers 550 can be layers of tantalium (Ta), or any other suitable light blocking material.

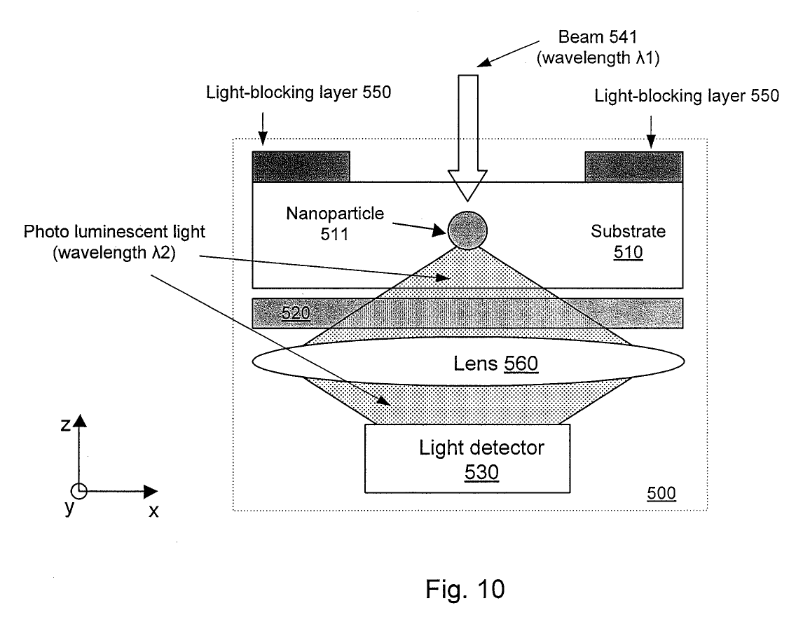

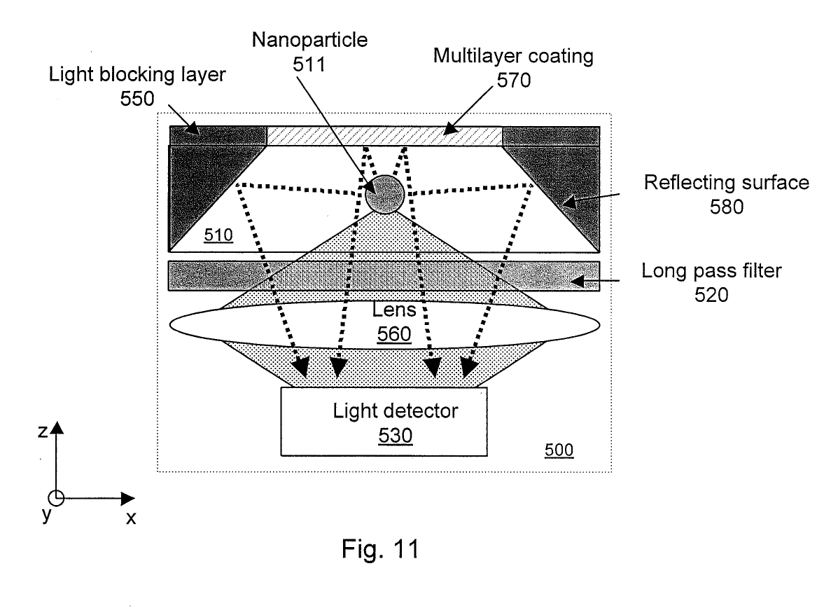

Lens 560 (as shown in FIGS. 10 and 11), and multilayer coating 570 and reflecting surfaces 580 (as shown in FIG. 11) can be added to measuring device 500 to further improve the signal-to-noise ratio by guiding more light to light detector 530. Lens 560 is positioned between filter 520 and light detector 530, as illustrated in FIGS. 10 and 11.

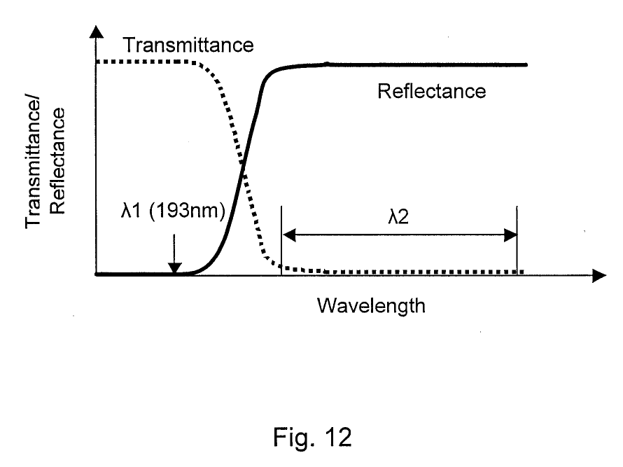

Multilayer coating 570 is positioned on the upper surface of substrate 510 in the opening between light-blocking layers 550, as illustrated in FIG. 11. Multilayer coating 570 can be any multilayer coating having the properties shown in FIG. 12, wherein light of wavelength λ1 is transmitted and light of wavelength λ2 is reflected. Reflecting surfaces 580 can be any reflecting surface that reflects light of wavelength λ2, such as, for example, a metal mirror, or a dielectric interface using total internal reflection.

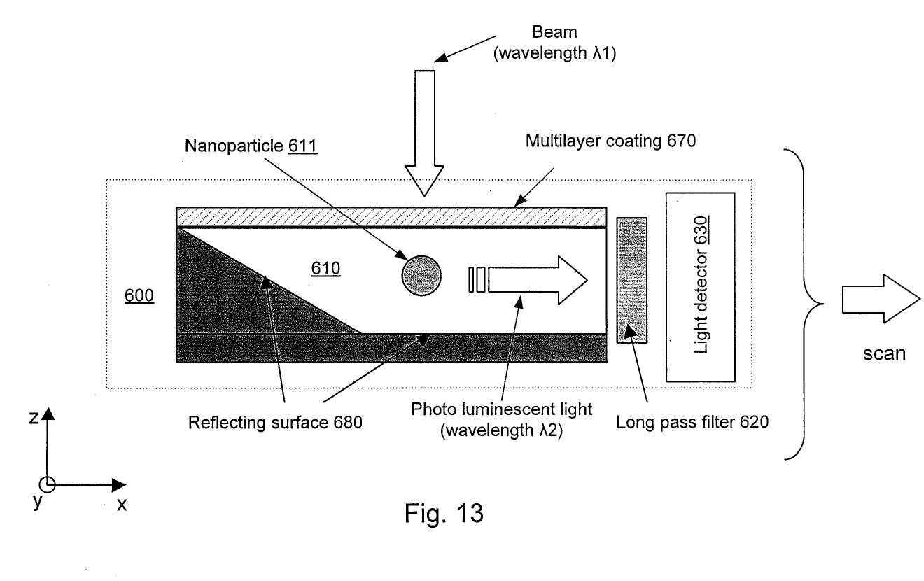

FIG. 13 shows the configuration of an aerial image measuring device 600 according to an embodiment of the invention. Measuring device 600 includes substrate 610, a filter 620, and a light detector 630, which are similar to substrate 510, filter 520, and light detector 530, respectively of FIG. 5A, 5B, and FIGS. 8 to 11. At least one nanoparticle 611 (similar to nanoparticles 511 of FIGS. 5A, 5B, and FIGS. 8 to 11) is embedded in substrate 610, as described above for FIGS. 5A and 5B. Multilayer coating 670 and reflecting surfaces 680 (similar to 570 and 580 as described for FIG. 11) are arranged on substrate 610 to guide light to detector 630, thereby improving the signal-to-noise ratio.

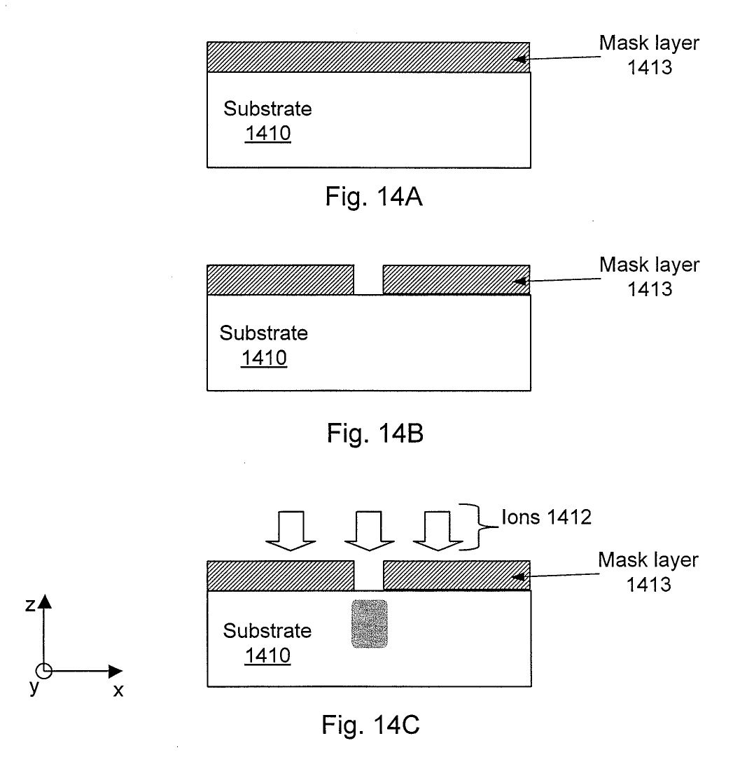

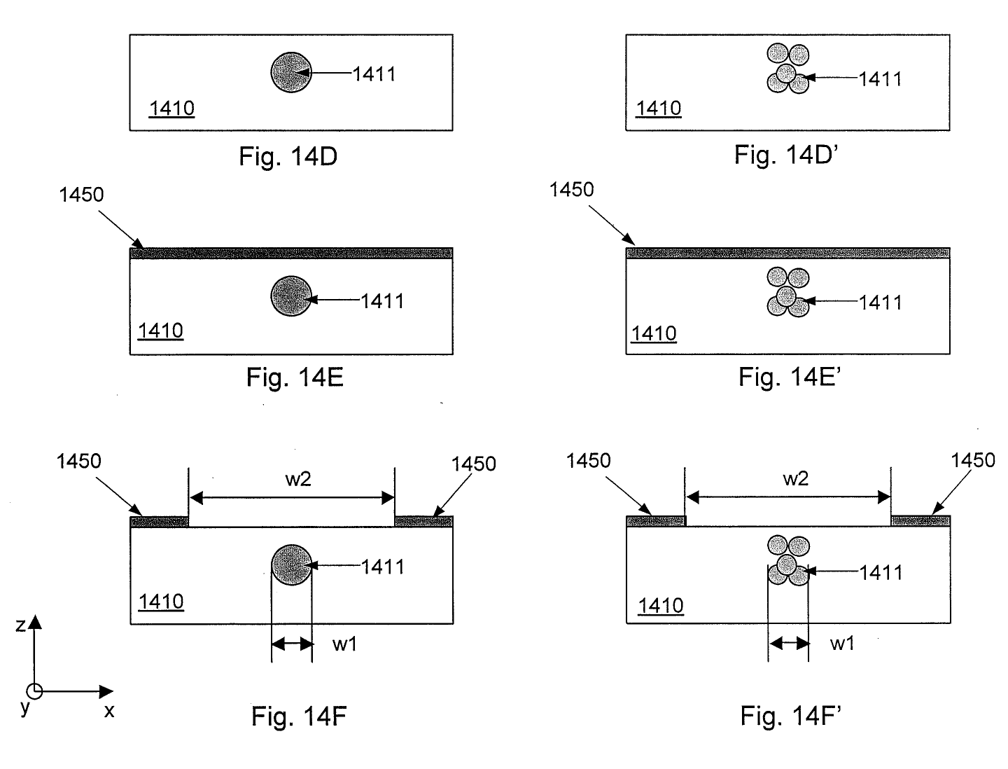

FIGS. 14A to 14F and 14D′ to 14F′ depict substrate 1410 after each step of a process for embedding nanoparticles 1411 in substrate 1410. Substrate 1410 is similar to substrate 510 and 610, and nanoparticles 1411 are similar to nanoparticles 511 and 611. Mask layer 1413 is deposited on substrate 1410 as shown in FIG. 14A. Mask layer 1413 can be photoresist, or any other suitable mask layer.

At least one opening is formed on the mask layer as shown in FIG. 14B, and ions 1412 of the nanoparticles are implanted in substrate 1410 through the openings in mask layer 1413, as shown in FIG. 14C. The ions can be Si ions, Ge ions, or ions of any other suitable type of nanoparticle. After the ions are implanted, mask layer 1413 is removed and the ions 1412 are annealed to form nanoparticles 1411 in substrate 1410, as shown in FIGS. 14D and 14D′.

The ions 1412 are annealed at a temperature greater than one hundred degrees Celsius to produce nanoparticles 1411 that are spherical nanocrystals having a width smaller than the feature size of an aerial image to be scanned. The annealing temperature and annealing time are adjusted to obtain desired properties (e.g., size and shape) and arrangements of nanoparticles 1411.

Ions 1412 can be annealed to form multiple nanoparticles 1411 in substrate 1410, arranged so that they do not touch each other. Forming multiple nanoparticles 1411 in substrate 1410, included in a measuring device (e.g., 500 or 600), can reduce the effect of shape deviation from an ideal sphere, and increase the signal-to-noise of the measuring device.

Ions 1412 can be annealed to form a single nanoparticle 1411, a cluster of nanoparticles 1411, or one or more columns of nanoparticles 1411 arranged along the Y-axis. A substrate 1410 having a single nanoparticle 1411, or a cluster of nanoparticles 1411, can be used to measure aerial images having two-dimensional features along the XY-plane. A substrate having one or more columns of nanoparticles 1411 arranged along the Y-axis can be used to measure aerial images having one-dimensional features.

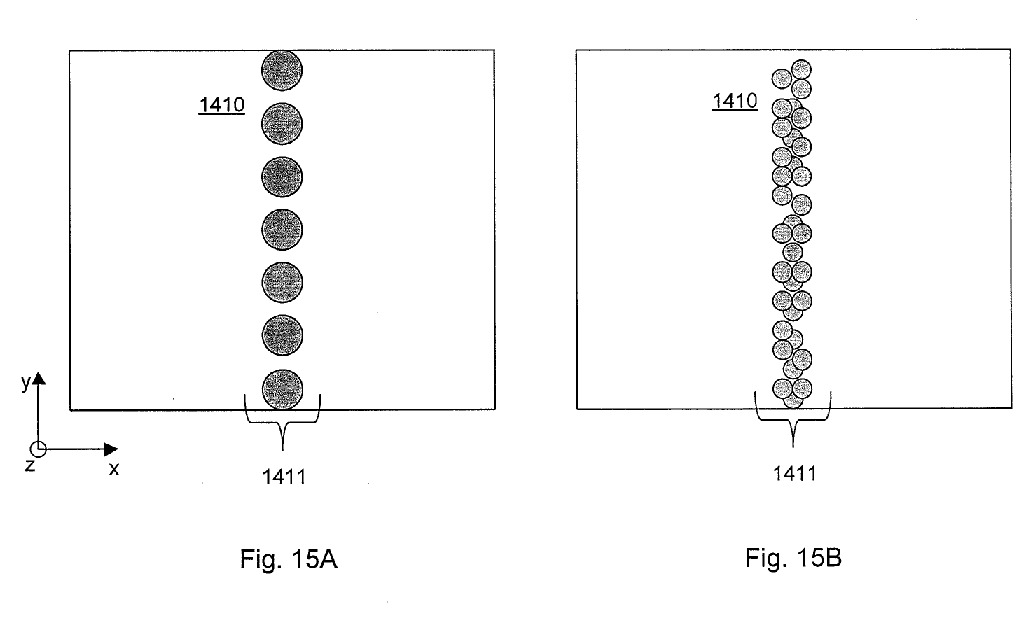

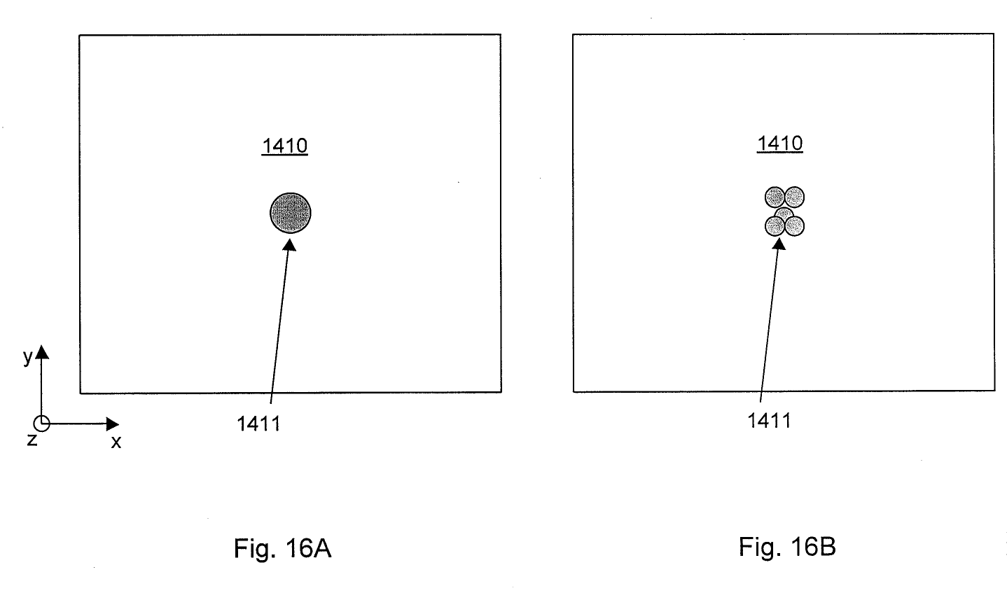

FIG. 14D illustrates a side view of substrate 1410 showing ions 1412 annealed to form a single column of nanoparticles 1411 distributed along the Y-axis (a top view of which is illustrated in FIG. 15A) or a single nanoparticle 1411 (a top view of which is illustrated in FIG. 16A.

FIG. 14D′ illustrates a side view of substrate 1410 showing ions 1412 annealed to form nanoparticles 1411 distributed in multiple columns along the Y-axis (a top view of which is illustrated in FIG. 15B), or a cluster of nanoparticles 1411 (a top view of which is illustrated in FIG. 16B).

FIGS. 14E and 14F illustrate forming a light-blocking layer 1450 on substrate 1410 as depicted in FIG. 14D, and FIGS. 14E′ and 14F′ illustrate forming a light-blocking layer 1450 on substrate 1410 as depicted in FIG. 14D′. A light blocking material is deposited onto substrate 1410 to form light-blocking layer 1450 (FIGS. 14E and 14E′), and an opening is created in light blocking layer 1450 (FIGS. 14F and 14F′). The light blocking material can be tantalum (Ta), or any other suitable light blocking material. The width (w2) of the opening is larger than the wavelength of beams of an aerial image (e.g., λ1).

The invention has been described above with respect to particular illustrative embodiments. It is understood that the invention is not limited to the above-described embodiments and that various changes and modifications may be made by those skilled in the relevant art without departing from the spirit and scope of the invention.

What is claimed is:

1. An aerial image measuring device used to measure an aerial image, the image measuring device comprising:
a substrate in which there are photo-luminescent nanoparticles that isotropically emit a photo-luminescent wavelength in response to an illuminated wavelength of the aerial image;
a filter that blocks the illuminated wavelength and is transparent to the photo-luminescent wavelength; and
a light detector that is sensitive to light of the photo-luminescent wavelength;
wherein the substrate is transparent to light of both the illuminated and the photo-luminescent wavelength, and light emitted by the nanoparticles passes through the filter and enters the light detector, which measures the aerial image, and
wherein the aerial image is scanned by the aerial image measuring device.

2. The image measuring device of claim 1, wherein the nanoparticles have a size smaller than both the illuminated wavelength and a feature size of the aerial image.

3. The image measuring device of claim 1, wherein the nanoparticles have a substantially spherical shape.

4. The image measuring device of claim 1, wherein the nanoparticles are arranged in columns.

5. The image measuring device of claim 1, wherein the nanoparticles have a size between 5 nm and 20 nm in diameter.

6. The image measuring device of claim 1, wherein the nanoparticles include Si, ZnO, and Ge nanoparticles.

7. The image measuring device of claim 1, wherein the substrate includes a SiO2 substrate.

8. The image measuring device of claim 1, wherein the nanoparticles are nanocrystals.

9. The image measuring device of claim 1, wherein the nanoparticles are arranged in the substrate such that they do not touch each other.

10. The image measuring device of claim 1, further comprising at least one light-blocking layer that blocks the illuminated wavelength, wherein the at least one light-blocking layer is arranged to reduce an amount of light of the illuminated wavelength that reaches the filter.

11. The image measuring device of claim 1, further comprising a lens arranged to guide light of the photo-luminescent wavelength to the light detector.

12. The image measuring device of claim 1, further comprising at least one reflecting surface arranged to deflect light of the photo-luminescent wavelength to the light detector.

13. The image measuring device of claim 1, wherein the light detector is insensitive to the illuminated wavelength.

14. A method of fabricating an image measuring device used to measure an aerial image, the method comprising:
depositing a mask layer on a substrate;
forming openings on the mask layer;
implanting ions of a nanoparticle in the substrate through the openings in the mask layer;
removing the mask layer from the substrate; and
annealing the ions to form nanoparticles in the substrate,
wherein the nanoparticles are photo-luminescent nanoparticles that isotropically emit a photo-luminescent wavelength in response to an illuminated wavelength, and
wherein the substrate is transparent to light of both the illuminated and the photo-luminescent wavelength.

15. The method of claim 14, wherein the mask layer includes photoresist.

16. The method of claim 14, wherein the ions are annealed in a manner adapted to produce nanoparticles having a size smaller than both the illuminated wavelength of the aerial image and a feature size of the aerial image.

17. The method of claim 14, further comprising depositing a light-blocking layer onto the substrate and creating an opening in the light blocking layer.

18. The method of claim 17, wherein a width of the opening in the light blocking layer is larger than an illuminated wavelength of the aerial image.

19. The method of claim 14, wherein the nanoparticles have a substantially spherical shape.

20. The method of claim 14, wherein the nanoparticles are arranged in columns.

21. The method of claim 14, wherein the nanoparticles have a size between 5 nm and 20 nm in diameter.

22. The method of claim 14, wherein the nanoparticles include Si, and Ge nanoparticles.

23. The method of claim 14, wherein the substrate includes a SiO2 substrate.

24. The method of claim 14, wherein the nanoparticles are nanocrystals.

25. The method of claim 14, wherein the nanoparticles are arranged in the substrate such that they do not touch each other.
